(19) United States
(12) Patent Application Publication
(10) Pub. No.: US 2026/0340554 A1
(43) Pub. Date: Oct. 29, 2026

(54) Behavioral AI Nexus (BAN): Cognitive-Emotional Framework and Operating System for Adaptive, Human-Centric Organizations

(71) Applicants: Shrikarnag Bangalore Prahallada, Austin, TX (US); Ranjitha Sridhar Rao Nag, Austin, TX (US); Lohith Dayananda Ram, Austin, TX (US); Rudri Jani, Ahmedabad (IN); Shrivatsa Bangalore Prahallada, Poway, CA (US); Deepashree Abhaya, Poway, CA (US)

(72) Inventors: Shrikarnag Bangalore Prahallada, Austin, TX (US); Ranjitha Sridhar Rao Nag, Austin, TX (US); Lohith Dayananda Ram, Austin, TX (US); Rudri Jani, Ahmedabad (IN); Shrivatsa Bangalore Prahallada, Poway, CA (US); Deepashree Abhaya, Poway, CA (US)

(21) Appl. No.: 19/636,953

(22) Filed: Apr. 2, 2026

Related U.S. Application Data
(60) Provisional application No. 63/795,095, filed on Apr. 25, 2025.

(51) Int. Cl. G06Q 10/0637; G06F 40/30; G06Q 10/0635

(52) U.S. Cl. CPC G06Q 10/0637; G06F 40/30; G06Q 10/0635

(57) ABSTRACT

A computer-implemented system and method for adaptive organizational behavioral management. The system comprises a four-layer cognitive-emotional framework operating as an organizational operating system: a Perception Layer that captures real-time emotional and behavioral signals from enterprise communication, project management, and HR platforms; an Interpretation Layer that processes captured signals using natural language processing and behavioral modeling to map emotional states and team dynamics; a Foresight Layer that predicts behavioral risks including burnout, disengagement, and collaboration breakdown using neural network algorithms; and an Activation Layer that generates adaptive intervention recommendations for workflow adjustments, communication strategies, and resource allocation. The system operates through a closed-loop feedback mechanism wherein outcomes of implemented recommendations continuously refine the predictive models. The invention enables organizations to transition from reactive management systems to adaptive, human-centric ecosystems capable of anticipating and responding to behavioral and emotional dynamics in real time.

### CROSS-REFERENCE TO RELATED APPLICATIONS

This application claims the benefit of U.S. Provisional Application No. [INSERT PROVISIONAL APPLICATION NUMBER], filed Apr. 25, 2025, the entire contents of which are hereby incorporated by reference.

### FIELD OF THE INVENTION

The present invention relates generally to the field of artificial intelligence and enterprise software systems. More specifically, the invention relates to a cognitive-emotional framework and operating system that senses, predicts, and dynamically optimizes team behavior, emotional states, and cultural alignment within organizations in real time.

### BACKGROUND OF THE INVENTION

Modern organizations operate in increasingly complex environments where emotional dynamics, team behavior, and cognitive engagement play critical roles in performance and innovation. Despite significant advances in analytics and digital transformation, most enterprises remain behaviorally blind-they track outputs like sales or churn but fail to sense, predict, or adapt to the emotional and behavioral undercurrents that drive those outputs.

Prior technologies in the domain of affective computing, organizational behavior analytics, and HR software platforms have explored elements of emotion recognition, burnout prediction, and cultural assessment individually. Examples include sentiment analysis platforms analyzing text-based emotional cues, burnout prediction models based on interactional data, and cultural modeling research quantifying organizational values.

However, these prior art solutions generally operate in siloed, static, or reactive ways. They lack an integrated, real-time, dynamic system that not only senses behavior but actively predicts future behavioral states and adapts organizational processes accordingly.

The Behavioral AI Nexus (BAN) is novel because it synthesizes emotional sensing, behavioral forecasting, cultural DNA mapping, and adaptive workflow engineering into a unified, continuous, and proactive operating system. Unlike traditional systems, BAN offers anticipatory and prescriptive behavioral intelligence, forming the foundation for what is described as Organizational Consciousness.

### SUMMARY OF THE INVENTION

The present invention provides a computer-implemented system and method for sensing, predicting, and dynamically optimizing team behavior and emotional states within organizations, creating a real-time cognitive-emotional framework that enhances collaboration, resilience, and cultural alignment.

In one embodiment, the system operates through a four-phase engine comprising: (1) a Perception Layer that captures emotional and behavioral signals from communication, HR, and project management platforms; (2) an Interpretation Layer that maps emotional states and team dynamics using natural language processing and behavioral modeling; (3) a Foresight Layer that predicts behavioral risks and simulates interventions; and (4) an Activation Layer that recommends real-time workflow adjustments, communication strategies, and incentive alignments.

### DETAILED DESCRIPTION OF THE INVENTION

The Behavioral AI Nexus (BAN) is a cognitive-emotional framework and operating system that allows organizations to sense, predict, and optimize team behavior, emotional states, and cultural alignment in real time. BAN transforms traditional organizations into adaptive, human-centric ecosystems by embedding behavioral intelligence into daily operations.

### Perception Layer

The Perception Layer captures real-time emotional and behavioral signals from communication platforms, project management tools, HR systems, and learning platforms. The system integrates with existing enterprise software tools such as Slack, Teams, Jira, and HR information systems through APIs or connectors. The Perception Layer continuously monitors text-based communications, interaction frequency, response patterns, and collaboration metrics to extract behavioral and emotional signals.

### Interpretation Layer

The Interpretation Layer processes the captured data using natural language processing and behavioral modeling to map emotional states, team dynamics, and cultural patterns. This layer employs neural network algorithms inspired by human behavioral patterns to analyze the cognitive-emotional data and produce actionable interpretations of team and individual behavioral states.

### Foresight Layer

The Foresight Layer forecasts behavioral risks, such as burnout or disengagement, and simulates potential interventions. Using predictive models trained on historical behavioral data, the Foresight Layer identifies patterns that indicate emerging risks before they manifest in operational outcomes. The system evaluates multiple intervention scenarios and ranks them by predicted effectiveness.

### Activation Layer

The Activation Layer recommends real-time adjustments to workflows, team structures, communication methods, and incentive systems. Recommendations are generated based on the predictions from the Foresight Layer and are delivered to organizational leaders through dashboards, notifications, or integrated workflow triggers. The system creates a closed-loop feedback mechanism where the outcomes of implemented recommendations are captured by the Perception Layer, continuously refining the system's predictive accuracy.

### System Architecture

The overall system architecture integrates sensing nodes, behavioral graphs, adaptive workflow engines, communication coaches, and cultural mapping tools into a unified platform. The system operates as a closed-loop: data flows from enterprise platforms into the Perception Layer, through the Interpretation and Foresight Layers, to the Activation Layer, and the outcomes of recommended actions feed back into the system for continuous learning and refinement.

### Problem Solved

Traditional systems only track outputs without understanding emotional and behavioral drivers. BAN enables organizations to anticipate and adapt to human dynamics, improving resilience, engagement, and collaboration. Existing tools are reactive and fail to manage emotional dynamics that affect performance. BAN solves this by enabling early detection of burnout, disengagement, and collaboration risks, and by proactively guiding teams toward resilience and productivity.

### Possible Variations

BAN can operate on cloud, on-premises, or hybrid setups. The system can integrate additional data sources such as biometric wearables and can adjust its modules based on industry needs. BAN can be configured differently based on organizational needs, such as focusing on resilience in healthcare or innovation in technology companies.

### Other Uses and Applications

The Behavioral AI Nexus can be used in many areas beyond organizational management. In healthcare, it can monitor emotional states of medical teams to reduce burnout and improve patient care. In education, it can support emotional engagement and collaboration among faculty, staff, and students. In military and defense, it can enhance team cohesion, psychological resilience, and mission readiness. In sports, it can optimize team chemistry, performance dynamics, and mental readiness. BAN can even extend to smart cities, managing civic team coordination, emotional well-being of first responders, and citizen engagement programs. Since BAN's core capability is sensing, predicting, and optimizing human group dynamics, it is adaptable to any environment where human collaboration, emotional health, and performance are critical.

### BRIEF DESCRIPTION OF THE DRAWINGS

FIG. 1 illustrates the BAN System Architecture, showing the four layers: Perception Layer (capturing signals from Communication Platforms, Project Management Tools, HR Systems, and Learning Management), Interpretation Layer (Emotional and Behavioral Mapping), Foresight Layer (Predicting Behavioral Risks), and Activation Layer (Adaptive Outputs).

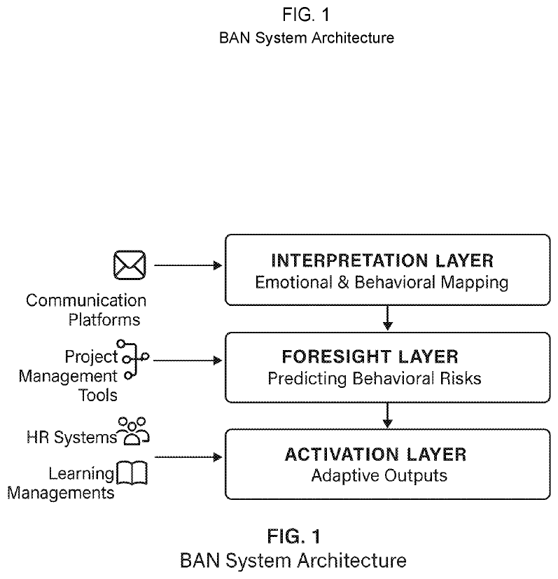

FIG. 2 illustrates the BAN Feedback Loop, showing the closed-loop cycle from Project Management Tools and Communication Data through Cognitive-Emotional Data processing, Cognitive-Emotional Analysis using Neural Network Algorithms Inspired by Human Behavioral Patterns, to Real-Time Outputs and Team Recommendations.

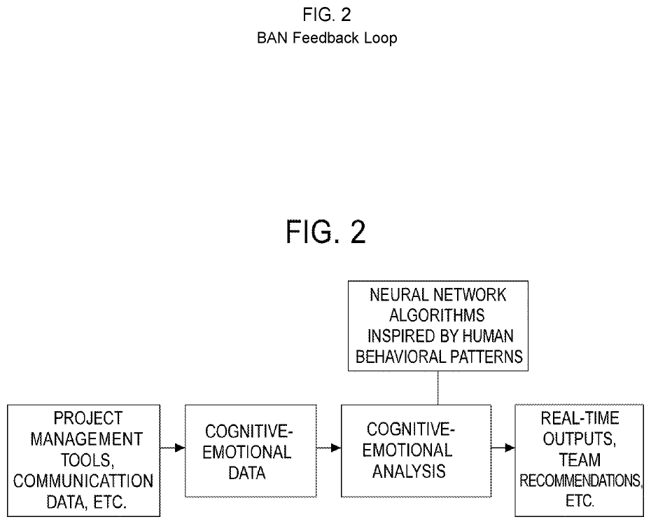

FIG. 3 illustrates an Example Use Case, showing the flow from Behavioral AI Nexus through Real-Time Behavior Analysis, Insight and Response Generation, to Adaptive Workflows and Culture Alignment.

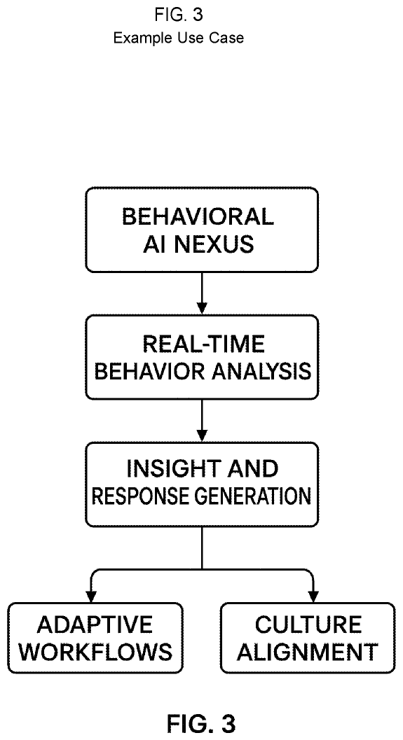

What is claimed is:

1. A computer-implemented method for adaptive organizational behavioral management, comprising:
(a) capturing, by one or more processors, real-time emotional and behavioral signals from a plurality of enterprise communication platforms, project management tools, and human resources systems;
(b) processing, by the one or more processors, the captured signals using natural language processing and behavioral modeling algorithms to generate emotional state mappings and team dynamics assessments;
(c) predicting, by the one or more processors using predictive models trained on historical behavioral data, one or more behavioral risks including at least one of burnout risk, disengagement risk, and collaboration breakdown risk;
(d) generating, by the one or more processors, one or more adaptive intervention recommendations comprising real-time adjustments to at least one of workflow configurations, team communication strategies, and resource allocation; and
(e) continuously updating the predictive models based on outcomes of implemented intervention recommendations through a closed-loop feedback mechanism.

2. The method of claim 1, wherein the emotional and behavioral signals are captured from at least two of: text-based communications, interaction frequency data, response time patterns, collaboration metrics, HR system records, and learning management system data.

3. The method of claim 1, wherein the natural language processing comprises sentiment analysis, emotion detection, and contextual behavioral pattern recognition applied to organizational communications.

4. The method of claim 1, wherein the predictive models employ neural network algorithms that identify patterns of behavioral deterioration prior to manifestation in operational performance metrics.

5. The method of claim 1, wherein the adaptive intervention recommendations include at least one of: workload redistribution, communication channel modification, meeting frequency adjustment, incentive realignment, and team composition changes.

6. The method of claim 1, further comprising generating a cultural alignment assessment by mapping organizational behavioral patterns against declared organizational values and strategic objectives.

7. The method of claim 1, further comprising simulating, by the one or more processors, a plurality of intervention scenarios and ranking the scenarios by predicted effectiveness before generating the adaptive intervention recommendations.

8. A system for real-time organizational behavioral intelligence, comprising:
one or more processors; and
a non-transitory computer-readable memory storing instructions that, when executed by the one or more processors, cause the system to:
(a) receive behavioral and emotional signal data from a plurality of integrated enterprise platforms through application programming interfaces;
(b) apply a multi-layer analytical framework comprising:
(i) a perception layer configured to extract emotional indicators and behavioral patterns from the received signal data;
(ii) an interpretation layer configured to map the extracted indicators to emotional states, team dynamics assessments, and cultural pattern models using natural language processing and behavioral modeling;
(iii) a foresight layer configured to predict behavioral risks and simulate intervention outcomes using predictive models; and
(iv) an activation layer configured to generate and deliver adaptive recommendations for organizational adjustments; and
(c) maintain a continuous feedback loop wherein outcomes of implemented recommendations are captured and used to refine the predictive models.

9. The system of claim 8, wherein the foresight layer employs neural network algorithms inspired by human behavioral patterns to forecast behavioral risks at least 7 days before manifestation in operational metrics.

10. The system of claim 8, wherein the activation layer delivers recommendations through at least one of: integrated dashboards, automated notifications, workflow trigger systems, and communication coaching interfaces.

11. The system of claim 8, wherein the system is deployable in at least one of: cloud-based, on-premises, and hybrid computing environments.

12. The system of claim 8, further comprising integration with biometric wearable devices for capturing physiological stress indicators as additional input to the perception layer.

13. A non-transitory computer-readable medium storing instructions that, when executed by one or more processors, cause the one or more processors to perform a method comprising:
continuously monitoring behavioral and emotional signals across a plurality of enterprise communication and collaboration platforms;
constructing a dynamic behavioral graph representing individual and team emotional states, interaction patterns, and cultural alignment metrics;
applying predictive analytics to the behavioral graph to identify emerging behavioral risks;
generating adaptive organizational recommendations based on the identified risks; and
updating the behavioral graph and predictive models based on organizational responses to the recommendations.

14. The non-transitory computer-readable medium of claim 13, wherein the behavioral graph comprises nodes representing individual contributors, teams, and organizational units, and edges representing communication frequency, sentiment, and collaboration quality.

15. The non-transitory computer-readable medium of claim 13, wherein the adaptive organizational recommendations are industry-configurable for at least one of: healthcare, technology, defense, education, and professional services environments.
